(19) United States
(12) Patent Application Publication
(10) Pub. No.: US 2013/0090146 A1
(43) Pub. Date: Apr. 11, 2013

(54) APPARATUS AND METHOD FOR TRANSMITTING INFORMATION REGARDING POWER COORDINATION IN MULTI-COMPONENT CARRIER SYSTEM

(71) Applicants: Ki Bum Kwon, Seoul (KR); Myung Cheul Jung, Seoul (KR); Sung Jin Suh, Seoul (KR)

(72) Inventors: Ki Bum Kwon, Seoul (KR); Myung Cheul Jung, Seoul (KR); Sung Jin Suh, Seoul (KR)

(73) Assignee: Pantech R&D Center, I-2, DMC, Seoul (KR)

(21) Appl. No.: 13/704,126

(22) PCT Filed: Aug. 10, 2011
(86) PCT No.: PCT/KR2011/005858

§ 371 Date: Dec. 13, 2012

(30) Foreign Application Priority Data
Aug. 13, 2010 (KR) 102010078160

(51) Int. Cl. H04W 72/04

(52) U.S. Cl. CPC H04W 72/0473
USPC 455/509; 455/522

(57) ABSTRACT

A method and apparatus for transmitting information regarding power coordination (PC) by a mobile station (MS) in a multi-component carrier system are provided. The method includes: setting information regarding power coordination (PC) indicating an amount or a range of power which is used to adjust uplink maximum transmission power of the MS, and transmitting the information regarding PC to a base station (BS). The information regarding PC is varied according to the number of component carriers configured in the MS. A scheduling error in the BS due to ambiguity of PC can be reduced and scheduling can be performed adaptively to maximum transmission power of a provided mobile station (MS) or a component carrier.

### CROSS-REFERENCE TO RELATED APPLICATIONS

This application is the National Stage Entry of International Application No. PCT/KR2011/005858, filed on Aug. 10, 2011 and claims priority from and the benefit of Korean Patent Application No. 10-2010-0078160, filed on Aug. 13, 2010, both of which are hereby incorporated by reference for all purposes as if fully set forth herein

### BACKGROUND

1. Field

The present invention relates to wireless communication and, more particularly, to an apparatus and method for transmitting information regarding power coordination in a multi-component carrier system.

2. Discussion of the Background

A 3GPP (3rd Generation Partnership Project) LTE (Long Term Evolution and an IEEE (Institute of Electrical and Electronics Engineers) 802.16m have been developed as candidates of a next-generation wireless communication system. The 802.16m standard involves two aspects: continuity of the past of correcting the existing 802.16e standard; and continuity of the future as a standard for a next-generation IMT-Advanced system. Thus, the 802.16m standard is required to meet advanced requirements for the IMT-Advanced system while maintaining compatibility with a mobile WiMAX system based on the 802.16e standard.

A wireless communication system generally uses a single bandwidth to transmit data. For example, a 2nd-generation wireless communication system uses a bandwidth of 250 KHz to 1.25 MHz, and a 3rd-generation wireless communication system uses a bandwidth of 5 MHz to 10 MHz. In order to support an increasing transmission capacity, recently, the 3GPP LTE or the 802.16m continues to extend a bandwidth of 20 MHz or larger. Increasing the bandwidth to increase the transmission capacity would be unavoidable, but the support of a large bandwidth may cause much power consumption in case in which the level of a required service is low.

Thus, a multi-carrier system has emerged to define carriers having a single bandwidth and a central frequency and transmit and/or receive data in a wideband through multiple carriers. It supports both a narrowband and a wideband by using one or more carriers. For example, if a single carrier corresponds to a bandwidth of 5 MHz, a bandwidth of a maximum 20 MHz can be supported by using four carriers.

One of methods for effectively utilizing resources of a mobile station (MS) by a base station (BS) is using power information of the MS. A power control technology is an essential core technology for minimizing an interference element to effectively distribute resources and reducing battery consumption of a MS in wireless communication. The MS may determine uplink transmission power according to scheduling information such as transmission power control (TPC), modulation and coding scheme (MCS), a bandwidth, and the like, allocated by the BS.

Here, as a multi-component carrier system has been introduced, uplink transmission power of component carriers is required to be collectively considered, making it complicated to control power of the MS. Such complexity may cause a problem in the aspect of maximum transmission power of the MS. In general, the MS is to operate with power lower than the maximum transmission power, transmission power within an allowable range.

If the BS performs scheduling requesting transmission power higher than the maximum transmission power, actual uplink transmission power would exceed the maximum transmission power. This is because power control of multi-component carriers is not clearly defined or because information regarding uplink transmission power is not sufficiently shared by the MS and the base station.

### SUMMARY

An aspect of the present invention provides an apparatus and method for transmitting information regarding power coordination in a multi-component carrier system.

Another aspect of the present invention provides an apparatus and method for receiving information regarding power coordination in a multi-component carrier system.

Another aspect of the present invention provides an apparatus and method for configuring information regarding power coordination in a multi-component carrier system.

Another aspect of the present invention provides an apparatus and method for transmitting and receiving information regarding power coordination in consideration of the number of component carriers configured in a multi-component carrier system.

Another aspect of the present invention provides an apparatus and method for transmitting and receiving information regarding power coordination varying according to the number of component carriers as set through an RRC connection reconfiguration procedure in a multi-component carrier system.

Another aspect of the present invention provides an apparatus and method for generating an RRC connection reconfiguration message including information regarding power coordination set in consideration of a communication environment of a mobile station (MS) in a multi-component carrier system.

Another aspect of the present invention provides an apparatus and method for transmitting information regarding a scheduling sequence determined by the number of component carriers (CCs) of an MS and the number of radio frequencies (RFs).

According to an aspect of the present invention, there is provided a method for transmitting information regarding power coordination by a mobile station (MS) in a multi-component carrier system. The method includes setting information regarding power coordination (PC) indicating an amount or a range of power which is used to adjust uplink maximum transmission power of the MS, and transmitting the information regarding PC to a base station (BS). The information regarding PC is varied according to the number of component carriers configured in the MS.

According to another aspect of the present invention, there is provided a method for receiving information regarding power coordination (PC) by a BS in a multi-component carrier system. The method includes receiving, from a mobile station (MS), information regarding PC indicating an amount or a range of power which is used to adjust uplink maximum transmission power regarding the MS, configuring an uplink grant for the MS based on the information regarding PC, transmitting, to the MS, the configured uplink grant, and receiving, from the MS, uplink data generated based on the configured uplink grant and the information regarding PC.

According to yet an aspect of the present invention, there is provided a mobile station (MS) for transmitting information regarding power coordination (PC) in a multi-component carrier system. The MS includes a PC table storage unit storing a PC table which maps a sequence of predefined communication environment to an amount or range of PC, the communication environment being specified by the number of component carriers, and the number of supportable radio frequencies (RFs), a PC information generation unit generating information regarding PC indicating the amount or range of PC with reference to the PC table, and an RRC message transceiver unit transmitting an RRC message including the information regarding PC. When the number of component carriers and the number of supportable RFs are changed, the PC information generation unit changes the information regarding PC.

According to yet an aspect of the present invention, there is provided an apparatus for receiving information regarding power coordination (PC) in a multi-component carrier system. The apparatus includes an RRC message transceiver unit receiving an RRC message including information regarding PC indicating an amount or a range of power which is used to adjust maximum transmission power of uplink transmission, a scheduling unit configuring a scheduling parameter, a scheduling validity determination unit determining whether or not uplink transmission based on the configured scheduling parameter is made within the range of maximum transmission power, and an uplink grant transmission unit transmitting an uplink grant comprising the configured scheduling parameter.

According to embodiments of the present invention, in the multi-component carrier system, since the range of power coordination is informed to a BS explicitly, a scheduling error in the BS due to ambiguity of power coordination can be reduced and scheduling can be performed adaptively to maximum transmission power of a provided MS or a component carrier.

In particular, since information regarding power coordination variably set in consideration of the number of component carriers configured in the MS is signaled, scheduling efficiency of a scheduler can be maximized.

### BRIEF DESCRIPTION OF THE DRAWINGS

FIG. 1 illustrates a wireless communication system.

FIG. 2 is a view for explaining the intra-band contiguous carrier aggregation.

FIG. 3 is a view for explaining the intra-band noncontiguous carrier aggregation.

FIG. 4 is a view for explaining the inter-band carrier aggregation.

FIG. 5 shows a linkage between downlink component carriers and uplink component carriers in a multi-carrier system.

FIG. 6 shows an example of a graph surplus power over time-frequency axis according to an embodiment of the present invention.

FIG. 7 shows another example showing a graph surplus power over time-frequency axis according to an embodiment of the present invention.

FIG. 8 is a conceptual view of an influence of uplink scheduling of a base station (BS) on transmission power of a mobile station (MS) in the wireless communication system.

FIG. 9 is a view for explaining an amount of power coordination and maximum transmission power in a multi-component carrier system according to an embodiment of the present invention.

FIG. 10 is a flow chart illustrating a process of a method for transmitting information regarding power coordination in a multi-component carrier system according to an embodiment of the present invention.

FIG. 11 is a flow chart illustrating a process of a method for transmitting information regarding power coordination in a multi-component carrier system according to another embodiment of the present invention.

FIG. 12 is a flow chart illustrating a process of a method for transmitting information regarding power coordination by a mobile station (MS) in a multi-component carrier system according to an embodiment of the present invention.

FIG. 13 is a flow chart illustrating a process of a method for receiving information regarding power coordination by a base station in a multi-component carrier system according to an embodiment of the present invention.

FIG. 14 is a schematic block diagram showing an apparatus for transmitting information regarding power coordination and an apparatus for receiving information regarding power coordination in a multi-component carrier system according to an embodiment of the present invention.

### DETAILED DESCRIPTION OF THE ILLUSTRATED EMBODIMENTS

Exemplary embodiments of the present invention will now be described in detail with reference to the accompanying drawings. The same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms. It will be understood that when an element or layer is referred to as being “on” or “connected to” another element or layer, it can be directly on or directly connected to the other element or layer, or intervening elements or layers may be present.

In the present disclosure, a wireless communication network will be described, and an operation performed in the wireless communication network may be performed in a process of controlling a network and transmitting data by a system (e.g., a base station (BS)) administering the corresponding wireless communication network or may be performed in a mobile station (MS) connected to the corresponding wireless network.

FIG. 1 illustrates a wireless communication system.

With reference to FIG. 1, the wireless communication system 10 is widely disposed to provide various communication services such as voice and packet data, or the like.

The wireless communication system 10 includes at least one base station (BS) 11. Each BS 11 provides a communication service to particular geographical areas (which are generally called cells) 15a, 15b, and 15c. The cells may be divided into a plurality of areas (which are generally called sectors).

A mobile station (MS) 12 may be fixed or mobile and may be referred to by other names such as user equipment (UE), mobile terminal (MT), user terminal (UT), subscriber station (SS), wireless device, personal digital assistant (PDA), wireless modem, handheld device, etc.

The BS 11 generally refers to a fixed station that communicates with the MS 12 and may be called by other names such as evolved-node B (eNB), base transceiver system (BTS), access point (AP), etc. Cells 15a, 15b, and 15c may be construed to have a comprehensive meaning indicating partial areas covered by the BS 11, and may include various coverage areas such as a mega-cell, a macro-cell, a micro-cell, a pico-cell, a femto-cell, and the like.

Hereinafter, downlink (DL) refers to communication from the BS 11 to the MS 12, and uplink (UL) refers to communication from the MS 12 to the BS 11. In downlink, a transmitter may be part of the BS 11 and a receiver may be part of the MS 12. In uplink, a transmitter may be part of the MS 12 and a receiver may be part of the BS 11.

There is no limitation in multi-access schemes applied to the wireless communication. Namely, various multi-access schemes such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used. A TDD (Time Division Duplex) scheme in which transmission is made by using a different time or an FDD (Frequency Division Duplex) scheme in which transmission is made by using different frequencies may be applied to an uplink transmission and a downlink transmission.

The layers of the radio interface protocol between the MS and a network may be divided into a first layer L1, a second layer L2, and a third layer L3 based on the three lower layers of an open system interconnection (OSI) standard model widely known in communication systems.

A physical layer, a first layer, is connected to a medium access control (MAC) layer, an upper layer, via a transport channel, and data is transferred between the MAC layer and the physical layer via the transport channel. Meanwhile, between different physical layers, namely, between a physical layer of a transmitting side and that of a receiving side, data is transferred via a physical channel. There are some physical control channels used in the physical layer. A physical downlink control channel (PDCCH) transmitting physical control information provides information regarding a resource allocation of a PCH (paging channel) and a DL-SCH (downlink shared channel) and information regarding an HARQ (hybrid automatic repeat request) related to a DL-SCH to the MS. The PDCCH may carry an uplink grant indicating a resource allocation of uplink transmission to the MS. A PCFICH (physical control format indicator channel) informs the MS about the number of OSDM symbols used in the PDCCH, and is transmitted at every subframe. A PHICH (physical Hybrid ARQ Indicator Channel) carries an HARQ ACK/NACK signal in response to uplink transmission. A PUSCH (Physical uplink shared channel) carries a UL-SCH (uplink shared channel).

A situation in which the MS transmits the PUCCH or the PUSCH is as follows.

The MS configures the PUCCH with respect to one or more information among information regarding a precoding matrix index (PMI) or a rank indicator (RI) selected based on a channel quality information (CQI) or measured space channel information, and periodically transmits the PUCCH to the BS. Also, the MS must transmit information regarding an ACK/NACK (Acknowledgement/non-acknowledgement) regarding downlink data received from the BS to the BS after a certain number of subframes upon receiving the downlink data. For example, when downlink data is received in an nth subframe, the MS transmits a PUCCH including ACK/NACK information with respect to the downlink data in (n+4) subframe. When ACK/NACK information cannot be transmitted on the PUCH allocated from the BS, or when a PUCCH for transmitting ACK/NACK is not allocated from the BS, the MS may carry and transmit ACK/NACK information in the PUSCH.

A radio data link layer, a second layer, includes a MAC layer, an RLC layer, and a PDCP layer. The MAC layer, responsible for handling mapping between a logical channel and a transport channel, selects an appropriate transport channel in order to transmit data transferred from the RLC layer, and adds required control information to a header of a MAC PDU (Protocol Data Unit). The RLC layer, an upper layer of the MAC layer, supports reliable data transmission. In order to configure data having an appropriate size fitting a radio interface, the RLC layer segments and concatenates RLC SDUs (Service Data Units) transferred from the upper layer. The RLC layer of a receiver supports a data reassembling function in order to recover the original RLC SDUs from the received RLC PDUs. The PDCP (Packet Data Convergence Protocol) layer is used only in a packet exchange area, and may compress a header of an IP packet and transmits packet data in a radio channel to enhance transmission efficiency of the packet data.

The RRC layer, a third layer, serves to control a lower layer and exchange radio resource control information between the MS and the network. Various RRC states such as an idle mode, an RRCC connected mode, or the like, are defined according to a communication state of the MS, and a transition between RRCs can be performed as necessary. In the RRC layer, various procedures related to a radio resource management, such as a system information broadcast, an RRC connection management procedure, a multi-component carrier set-up procedure, a radio bearer control procedure, a security procedure, a measurement procedure, a mobility management procedure (handover), or the like.

A carrier aggregation (CA) supports a plurality of carriers, which is also called a spectrum aggregation or a bandwidth aggregation. Individual unit carriers grouped through carrier aggregation are called component carriers (CCs). Each of the component carriers (CCs) is defined by bandwidth and central frequency. The carrier aggregation is introduced to support increased throughput, prevent an increase in cost otherwise caused by an introduction of a broadband radio frequency (RF) element, and guarantee compatibility with an existing system. For example, when five component carriers are allocated as granularity of carrier unit having a 5 MHz bandwidth, a maximum 20 MHz bandwidth can be supported.

Component carriers (CCs) may be divided into a primary component carrier (PCC) and a secondary component carrier (SCC) depending on whether or not they are activated. The primary component carrier is a constantly activated carrier, and the secondary component carrier is a carrier activated or deactivated according to particular conditions.

Here, activation refers to a state in which traffic data is transmitted or received or a state in which traffic data is ready to be transmitted or received. Deactivation refers to a state in which traffic data cannot be transmitted or received and measurement or transmission or reception of minimum information is available.

The MS may use only one primary component carrier or one or more secondary component carriers along with a primary component carrier. The MS may be allocated the primary component carrier and/or the secondary component carrier from the BS.

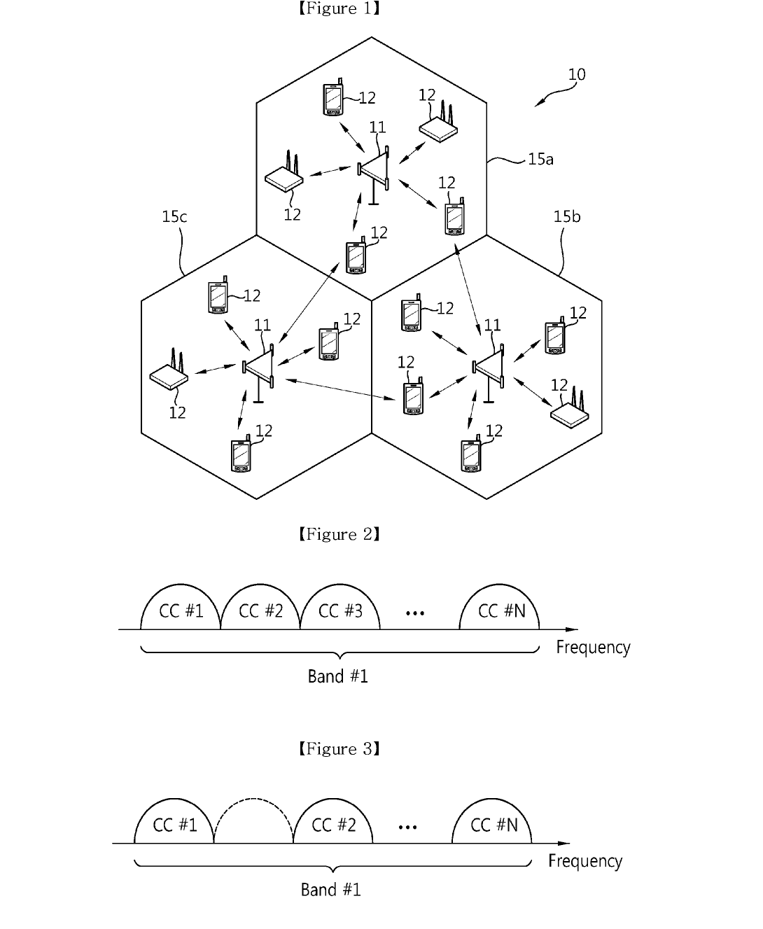

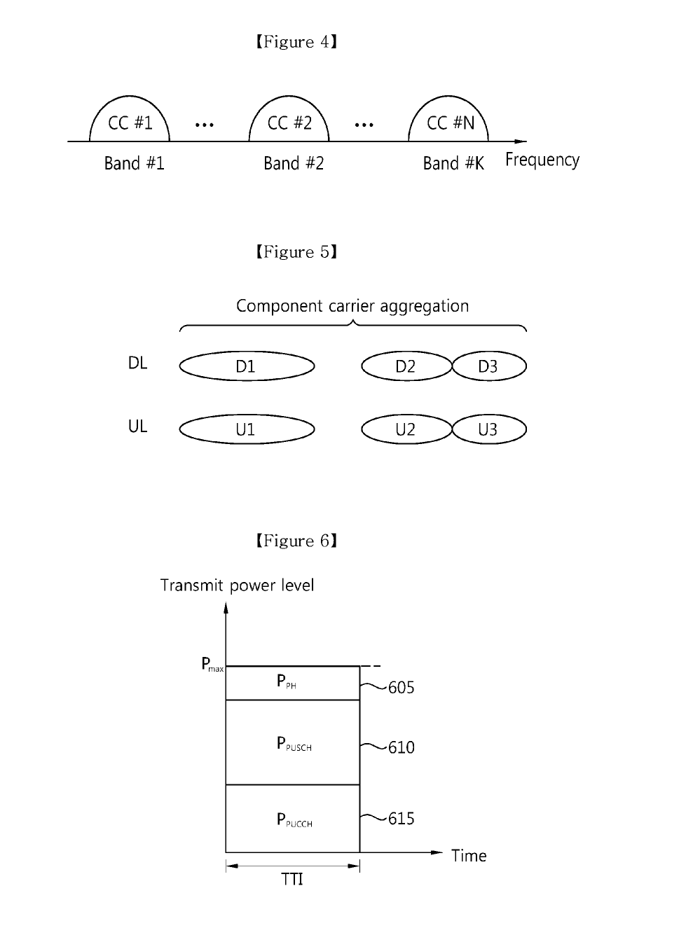

The carrier aggregation may be divided into an intra-band contiguous carrier aggregation as shown in FIG. 2, an intra-band non-contiguous carrier aggregation as shown in FIG. 3, and an inter-band carrier aggregation as shown in FIG. 4.

First, with reference to FIG. 2, the intra-band carrier aggregation (CA) is made among continuous component carriers in the identical band. For example, CC#1, CC#2, CC#3, . . . , CC#N, aggregated CCs, are all adjacent to each other.

With reference to FIG. 3, an intra-band non-contiguous CA is made among discontinuous CCs. For example, CC#1 and CC#2, aggregated CCs, are spaced apart by a particular frequency.

With reference to FIG. 4, an inter-band CA is made as one or more CCs are aggregated in different frequency bands when a plurality of CCs exist. For example, CC#1, an aggregated CC, exists in band #1, CC#2, an aggregated CC, exists in band #2.

The number of aggregated carriers may be set to be different for downlink and uplink. An aggregation in which the number of downlink component carriers is equal to the number of uplink component carriers is called a symmetric aggregation, and an aggregation in which the number of downlink component carriers is different from the number of uplink component carriers is called an asymmetric aggregation.

Sizes (i.e., bandwidths) of component carriers may vary. For example, when five component carriers are used to configure a 70 MHz band, the five carriers may be configured as follows: 5 MHz CC (carrier #0)+20 MHz CC (carrier #1)+20 MHz CC (carrier #2)+20 MHz CC (carrier #3)+5 MHz CC (carrier #4).

Hereinafter, a multi-carrier system refers to a system supporting carrier aggregation. In the multi-carrier system, a contiguous carrier aggregation and/or a non-contiguous carrier aggregation may be used, or either the symmetrical aggregation or the asymmetrical aggregation may be used.

FIG. 5 illustrates a linkage between downlink component carriers and uplink component carriers in the multi-carrier system.

With reference to FIG. 5, downlink component carriers (DL CC) D1, D2, and D3 are aggregated in downlink, and uplink component carriers (UL CC) U1, U2, and U3 are aggregated in uplink. Here, Di is an index (i=1, 2, 3) of the DL CC, and Ui is an index of UL CC. At least one DL CC is a primary component carrier (PCC), and the other remaining DLCC are secondary component carriers (SCC). Similarly, at least one UL CC is a PCC, and the other remaining UL CCs are SCCs. For example, D1 and U1 are PCCs, and D2, U2, D3, and U3 are SCCs.

In an FDD system, the DL CCs and the UL CCs are set to be connected by 1:1, and in this case, D1 is set to be connected to U1, D2 to U2, and D3 to U3, in a one-to-one manner. The MS sets the linkage between the DL CCs and the UL CCs through system information transmitted by a logical channel BCCH or an MS-dedicated RRC message transmitted by a DCCH. Each linkage may be set to be cell-specific or may MS-specific.

FIG. 5 illustrates only the 1:1 linkage between the DL CCs and the UL CCs, but of course, a linkage of 1:n or a linkage of n:1 can be established. Also, the index of the component carriers may not be consistent with order of CCs or the position of a frequency band of corresponding CCs.

A primary serving cell refers to a serving cell providing a security input and Non-access stratum (NAS) mobility information in a state in which an RRC is established or re-established. At least one cell may be configured to form a set of serving cells along with a primary serving cell according to capabilities of the MS, and in this case, the at least one cell is called a secondary service cell.

Thus, the set of serving cells configured for one MS may include only a single primary serving cell or may include one primary serving cell and one or more secondary serving cells.

A DL CC corresponding to a primary serving cell is called a downlink primary component carrier (DL PCC), and an UL CC corresponding to a primary serving cell is called an uplink primary component carrier (UL PCC). Also, in downlink, a CC corresponding to a secondary serving cell is called a downlink secondary component carrier (DL SCC), and in uplink, a CC corresponding to a secondary serving cell is called an uplink secondary component carrier (UL SCC). The DL CC only may correspond to one serving cell, or the DL CC and the UL CC may correspond together to one serving cell.

Hereinafter, all embodiments disclosed in the present invention describe their subject matters in terms of CC. But it is obvious and possible to those skilled in the art to replace a CC for a serving cell with regard to those subject matters.

A power headroom (PH) will now be described.

A power headroom (PH) refers to extra power which can be additionally used in addition to power currently used for uplink transmission by the MS. For example, it is assumed that maximum transmission power, transmission power within an allowable range, of the MS is 10 W. It is also assumed that the MS currently uses 9 W in a frequency band of 10 MHz. The MS can additionally use 1 W, so PH is 1 W.

Here, when the BS allocates a frequency band of 20 MHz to the MS, power of 9×2=18 W is required. However, since the maximum power of the terminal 10 W, when power of 20 MHz is allocated to the MS, the MS cannot use the entirety of the frequency band or power may be insufficient so the BS cannot properly receive a signal from the MS. Thus, in order to solve this problem the MS reports the BS that power headroom is 1 W, so that the BS can perform scheduling within the range of power headroom. Such a report is called a power headroom report (PHR).

Since the PH is frequently changed, periodic PHR scheme may be used. According to the periodic PHR scheme, when a periodic timer expires, the MS triggers the PHR, and when the PH is reported, the MS reoperates the periodic timer.

Also, when a pass loss (PL) estimate value measured by the MS is changed by more than a certain reference value, the PHR may be triggered. The PL estimate value is measured by the MS based on a reference symbol received power (PSRP).

The PH (P_{PH}) is defined as the difference between maximum transmission power Pₘₐₓ configured in the MS as represented by Math Figure 1 and power P_{estimated} estimated regarding uplink transmission, and it is expressed as dB.

P_{PH}=Pₘₐₓ−P_{estimated}[dB] [Math Figure 1]

Power headroom (P_{PH}) may also be called remaining power or surplus power. Namely, a remainder value, excluding P_{estimated}, the sum of transmission power used by each CC, in the maximum transmission power of the MS set by the BS, is P_{PH}.

For example, P_{estimated} is equal to power P_{PUSCH} estimated regarding transmission of physical uplink shared channel (PUSCH). Thus, in this case, P_{PH} can be obtained by Math Figure 2 shown below:

P_{PH}=Pₘₐₓ−P_{PUSCH}[dB] [Math Figure 2]

In another example, P_{estimated} is equal to the sum of power P_{PUSCH} estimated regarding transmission of the PUSCH and power P_{PUCCH} estimated regarding transmission of physical uplink control channel (PUCCH). Thus, in this case, power headroom (PH) can be obtained by Math Figure 3 shown below:

P_{PH}=Pₘₐₓ−P_{PUCCH}−P_{PUSCH}[dB] [Math Figure 3]

The PH according to Math Figure 3 can be expressed on time and frequency axes in a graph as shown in FIG. 6. In FIG. 6, PH with respect to one CC is shown.

With reference to FIG. 6, the set maximum transmission power Pₘₐₓ of the MS includes P_{PH} (605), P_{PUSCH} (610) and P_{PUCCH} (615). Namely, the remainder, excluding P_{PUSCH}(610) and P_{PUCCH}(615), in Pₘₐₓ is defined as P_{PH} (605). Each power is calculated by transmission time interval (TTI).

A main serving cell is the only serving cell retaining a UL PCC for transmitting the PUCCH. Thus, a sub-serving cell cannot transmit the PUCCH, PH is determined as expressed by Math Figure 2, and a parameter and an operation with respect to the PHR method determined by Math Figure 3 are not defined.

Meanwhile, in the main serving cell, operation and parameters with respect to a PHR method determined by Math Figure 3 may be defined. When MS receives an uplink grant from the BS so it should transmit the PUSCH and simultaneously transmits the PUCCH in the same subframe according to a determined rule in the main serving cell, the MS calculates all the PHs according to Math Figure 2 and Math Figure 3 at a point in time at which the PHR is triggered, and transmits the same to the BS.

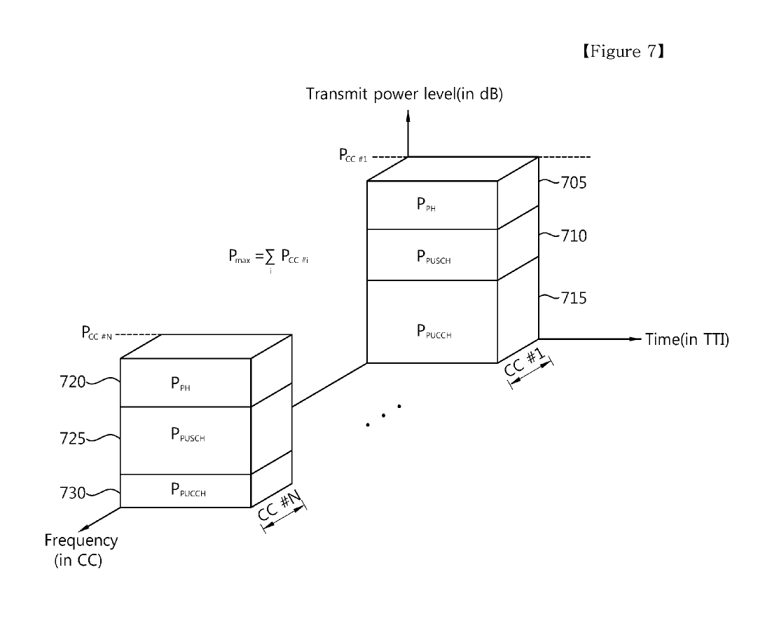

In the multi-component carrier system, PH can be individually defined regarding a plurality of set CCs, and FIG. 7 shows a graph in which PH is expressed on time and frequency axes.

With reference to FIG. 7, the maximum transmission power Pₘₐₓ set n the MS is equal to the sum of maximum transmission power PCC #1, PCC #2, . . . , PCC #N with respect to respective CC #1, CC #2, . . . , and CC #N. The maximum transmission power per CC can be generalized as expressed by Math Figure 4 shown below:

$${P}_{{CC}_{i}} = {P}_{max} - {\sum }_{j \neq i}^{ } {P}_{{CC}_{j}} \qquad [ Math Figure 4 ]$$

P_{PH}(705) of CC #1 is equal to P_{CC #1}-P_{PUSCH}(710)-P_{PUCCH}(715), and P_{PH}(720) is equal to P_{CC #n}-P_{PUSCH}(725)-P_{PUCCH}(730). In this manner, for the maximum transmission power configured in the MS in the multi-component carrier system, the maximum transmission power of each CC must be considered. Thus, the maximum transmission power in the multi-component carrier system is defined to be different from that in a single component carrier system.

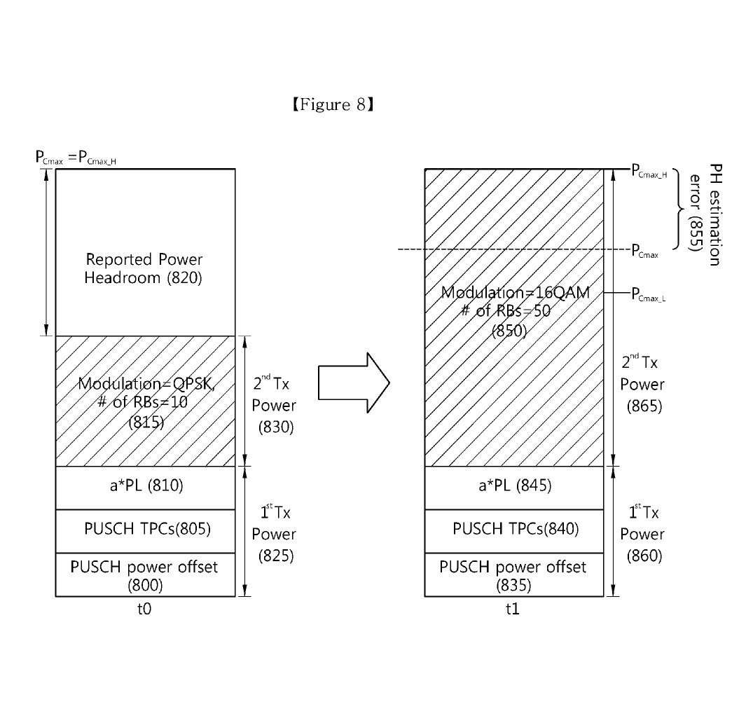

FIG. 8 is a conceptual view showing an influence of uplink scheduling of a base station (BS) on transmission power of a mobile station (MS) in the wireless communication system.

With reference to FIG. 8, the MS receives an uplink grant allowing uplink data transmission from the BS at time (or subframe) to through a PDCCH. Thus, the terminal should calculate an amount of transmission power according to the uplink grant at t0.

First, at time t0, the MS calculates first transmission power 825 in consideration of a PUSCH power offset value 800 and a transmission power control (TPC) value 805 received from the BS and an ‘a’ value (received from the BS), a weight, to a path loss (PL) 810 between the BS and the MS. The first transmission power (1st Tx Power) 825 is largely according to a parameter affected by a path environment between the BS and the MS and a parameter determined by a policy of a network. In addition, the MS calculates a second transmission power (2nd Tx Power) 830 in consideration of a scheduling parameter 815 indicating a QPSK modulation scheme and an allocation of ten resource blocks (RBs). The second transmission power 830 is transmission power changing through uplink scheduling of the BS.

Thus, the MS can calculate final uplink transmission power by adding the first transmission power 825 and the second transmission power 830. Here, the final uplink transmission power cannot exceed the set maximum transmission power (Pₘₐₓ) of the MS. In the example of FIG. 8, since the final transmission power is smaller than Pmax value at the time t0, so the uplink information according to set parameter can be transmitted. Also, there is power headroom (PH) 820, an extra with respect to transmission power, which can be additionally set. The PH 820 is transmitted by the MS to the BS according to a rule defined in the wireless communication system.

At time t1, the BS changes into a scheduling parameter 850 indicating a 16QAM modulation scheme and allocation of 50 resource blocks in consideration of transmission power which can be additionally set for the MS through information of PH 820. The MS resets second transmission power 865 according to the scheduling parameter 850. A first transmission power 860 at time t1 is determined in consideration of a PUSCH power offset value 835, a TPC value 840, and an ‘a’ value (received from the BS), a weight, to a PL 845 between the BS and the MS, and here, it is assumed that the first transmission power 860 is equal to the first transmission power 825 at time t0.

At time t1, Pmax is changed into a value close to Pₘₐₓ_{_{—}}_{L}, while the sum of the second transmission power 865 and the first transmission power 860 requested by the scheduling parameter 850 exceeds Pₘₐₓ. Namely, a PH estimated value error 855 by Pₘₐₓ_{_{—}}_{H}-Pₘₐₓ occurs. In this manner, when scheduling is performed on the uplink resource based only on PH information, the MS cannot set uplink transmission power expected by the BS, generating performance degradation. When the CC aggregation scheme is used, the PH estimated value error 855 is further increased. Thus, the MS is required to reduce the maximum transmission power, which is called power coordination.

No matter whether it is a single component carrier system or it is a multi-component carrier system, the maximum transmission power configured in the MS is affected by power coordination (PC) of the MS. PC refers to reducing the maximum transmission power configured in the MS within a certain allowed range, and it may be called a maximum power reduction (MPR). The reduced amount of power according to PC is called a PC amount. The reason for reducing the maximum transmission power configured in the MS is as follows. It happens that the maximum transmission power is required to be limited due to the form of a signal to be currently transmitted based on hardware configuration (in particular, radio frequency (RF)) in the MS.

Here, the hardware configuration in the MS includes RF, and this is may also be called an RF chain. The RF is characteristic in that it includes a combination of a power amplifier, a filter, an antenna, and the like, in the hardware configuration of the MS. Also, the RF may be defined by each of the power amplifier, the filter, and the antenna. One RF may be configured in one MS or a plurality of RFs may be configured in one MS. For example, when an MS has one antenna, the antenna is connected to a first power amplifier connected to a first filter, and simultaneously, the antenna is connected to a second power amplifier connected to a second filter, then, the one terminal constitutes two RF chains.

When an uplink transmission bandwidth is determined, a corresponding signal is controlled to be transmitted only with respect to a bandwidth set by the filter. Here, as the width of the bandwidth is larger, the number of taps (e.g., registers) constituting the filter is increased. In order to satisfy ideal filter characteristics, design complexity and size of the filter is increased exponentially in spite of the identical bandwidth.

Thus, interference power with respect to a band which is not to be transmitted to uplink due to the characteristics of the filter may be generated. In order to reduce such interference power, the interference power is required to be reduced by reducing the maximum transmission power through PC. The range of the maximum transmission power in consideration of PC is expressed by Math Figure 5 shown below;

P_{max-L}≦Pₘₐₓ≦P_{max-H} [Math Figure 5]

Here, Pₘₐₓ is the maximum transmission power configured in the MS, P_{max-L} is the lowest value of Pₘₐₓ, and P_{max-H} is the highest value of Pₘₐₓ. In detail, P_{max-L} and P_{max-H} are calculated by Math Figure 6 and Math Figure 7, respectively, shown below:

P_{max-L}=MIN[P_{Emax}−ΔT_{C},P_{powerclass}−PC−APC−ΔT_{C}] [Math Figure 6]

P_{max-H}=MIN[P_{Emax},P_{powerclass}] [Math Figure 7]

Here, MIN[a,b] is a smaller value among a and b, P_{Emax} is maximum power determined by RRC signaling of the BS, and ΔTC is an amount of power applied at an edge of a band when there is uplink transmission, which has a value of 1.5 dB or 0 dB according to a bandwidth. Ppowerclass is a power value according to several power classes defined to supply the specifications of various MSs in the system. In general, in the LTE system, power class 3 is supported and Ppowerclass by power class 3 is 23 dBm. PC is power coordination amount, and APC (additional power coordination) is an additional power coordination amount signaled by the BS. PC may be set to be within a particular range, or may be set by a particular constant. PC may be defined to be UE-specific, may be defined to CC-specific, or may be set to be within a range or by a constant in each CC. Also PC may be set by a range or a constant according to whether or not a PUSCH resource allocation of each CC is continuous or discontinuous. Also, PC may be set by a range or a constant according to whether or not PUCCH exists.

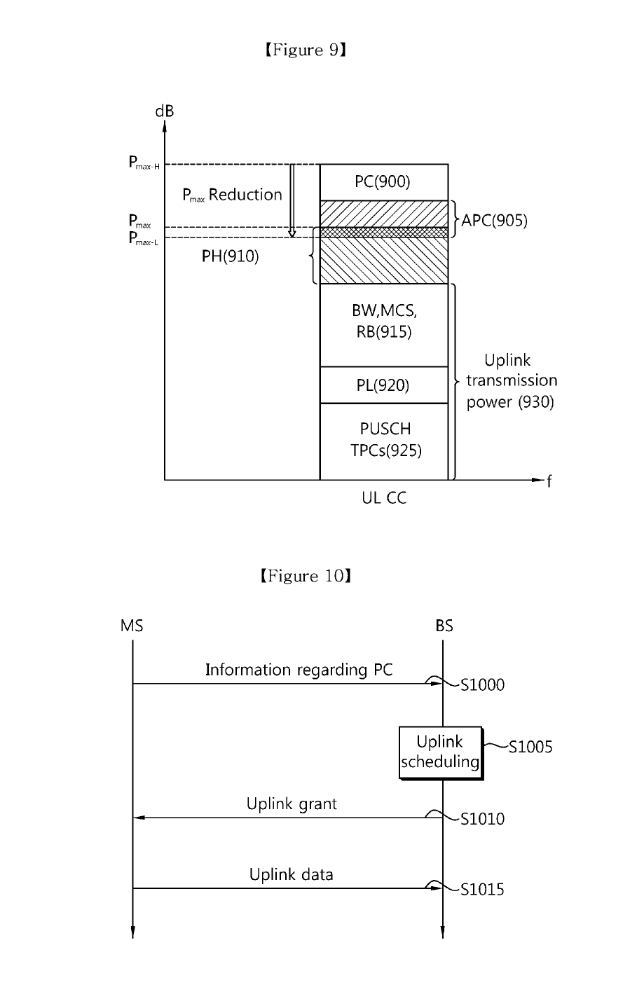

FIG. 9 is a view for explaining an amount of power coordination and maximum transmission power in a multi-component carrier system according to an embodiment of the present invention. It is assumed that only one UL CC is allocated to an MS for the sake of brevity.

With reference to FIG. 9, when it is assumed that ΔT_{c}=0, it is noted that the highest value P_{max-H} of the maximum transmission power Pₘₐₓ is 23 dB which corresponds to power class 3. The lowest value P_{max-L} of the maximum transmission power Pₘₐₓ is a value obtained by subtracting the power coordination amount PC 900 and additional power coordination amount APC 905 from the height value P_{max-H}. Namely, the MS reduces the lowest value P_{max-L} of the maximum transmission power Pₘₐₓ by using the power coordination amount PC 900 and the additional power coordination amount APC 905. The maximum transmission power Pₘₐₓ is determined between the highest value P_{max-H} and the lowest value P_{max-L}.

Meanwhile, uplink transmission power 930 appears as the sum of power 915 determined by bandwidth (BW), MCS, and RB, a pass loss (PL) 920, and PUSCH transmission power control (TPCs) 925. PH 910 is a value obtained by subtracting the uplink transmission power 930 from the maximum transmission power Pₘₐₓ.

In FIG. 9, only one UL CC is explained, but when a plurality of UL CCs are allocated, maximum transmission power will be given by terminal, rather than by UL CC, the maximum transmission power of a single UL CC is configured the same as the maximum transmission power of an MS. In other words, the transmission by an MS can be performed with the maximum transmission power for a single UL CC.

In calculating the maximum transmission power, P_{Emax}, ΔT_{C}, P_{powerclass}, and additional power coordination (APC) amount are information the BS knows about or may know about. However, the BS cannot know about the power coordination (PC) amount, so it cannot precisely know about the maximum transmission power according to the power coordination (PC) amount. In this case, when the MS reports PH to the BS, the BS can merely estimate about in which range the maximum transmission power will be in sub-frames in which the MS calculated the PH, through the PH. The BS performs uncertain uplink scheduling within the estimated maximum transmission power, so in a worst-case scenario, the BS may possibly perform scheduling with modulation/channel bandwidth/RB requiring transmission power higher than the maximum transmission power from the MS. This problem may severely arise in the multi-component carrier system.

When a plurality of CC exist and/or when one or more RFs exist, various communication environments would be established and a large number of uplink scheduling would be performed. This means that variance of power coordination would also be too various to be estimated. Thus, there is a need to newly design power coordination according to various numbers of cases in consideration of CC and RF as well as scheduling parameters (modulation, channel bandwidth, the number of RBs, etc.).

Hereinafter, a definition, a format, a transmission procedure of information regarding power coordination, and a message structure will now be described in detail.

1. Information Regarding Power Coordination (or Power Coordination Information (PCI)

When communication environments are not various, the range of power coordination of about 1 dB to 2 dB can be covered. In this case, the BS can easily estimate the range of power coordination, so the BS can perform scheduling without difficulties even without information regarding power coordination.

However, the MS may encounter various communication environments specified by the combination of the number of aggregatable CCs, the number of available RFs, a modulation scheme, an allocated frequency bandwidth, and the amount of resource blocks. For example, a communication environment may be specified by two CCs, one RF, 16 QAM, 20 MHz bandwidth, and ten resource blocks, while another communication environment may be specified by one CC, one RF, QPSK modulation, 10 MHz bandwidth, and five resource blocks. Namely, the respective communication environments may have a large number of cases.

Various communication environments inevitably require various variances with respect to power coordination. Thus, the MS is required to support various power coordination amounts or ranges with respect to various communication environments, and the BS is required to know about the various power coordination amounts or ranges supported by the MS to perform accurate scheduling. For accurate scheduling, the BS requires information regarding power coordination.

The information regarding power coordination is information regarding an amount or a range of power which is used to adjust the uplink maximum transmission power regarding the MS. The information regarding power coordination provides an amount or a range of power coordination specified for respective various communication environment conditions the MS may encounter. The information regarding power coordination is determined specifically by at least one of the number of CCs configured in the MS and the number of radio frequencies (RFs) supported for the MS. Because the MS explicitly or implicitly provides the information regarding power coordination to the BS, a scheduling error of the BS due to ambiguity of power coordination can be reduced and the BS can perform scheduling such that it is adaptive to the maximum transmission power for a given MS or for each CC.

2. Format of Information Regarding Power Coordination (PC)

(1) For example, information regarding PC explicitly describes an amount or a range of PC required for an MS under the condition in which a scheduling parameter is arbitrarily set.

The scheduling parameter is information determined by the combination of at least one of modulation, a channel bandwidth, and the number of resource blocks. Scheduling parameters obtained by applying certain values thereto are arbitrarily set. For example, Table 1 below shows an example of scheduling parameters.

TABLE 1

| | | Channel bandwidth/ | | | | | |
|---|---|---|---|---|---|---|---|
| | | Transmission bandwidth | | | | | |
| | | configuration (RB) | | | | | |
| Scheduling | | 1.4 | 3.0 | | 10 | 15 | 20 |
| Parameter | Modulation | MHz | MHz | 5 MHz | MHz | MHz | MHz |
| Sequence 0 | QPSK | >5 | >4 | >8 | >12 | >16 | >18 |
| Sequence 1 | 16 QAM | ≦5 | ≦4 | ≦8 | ≦12 | ≦16 | ≦18 |
| Sequence 2 | 16 QAM | >5 | >4 | >8 | >12 | >16 | >18 |

With reference to Table 1, the scheduling parameters are any one of sequence 0, sequence 1, and sequence 2. In the case of sequence 0, values applied to the respective scheduling parameters are as follows. Sequence 0 includes a state in which a channel bandwidth of 1.4 MHz and resources blocks larger than 5 resource blocks are allocated in a state in which the modulation scheme is QPSK. Also, a state in which a channel bandwidth of 3.0 MHz and resources blocks larger than 4 resource blocks are allocated in a state in which the modulation scheme is QPSK corresponds to sequence 0.

Also, a scheduling parameter based on a certain channel bandwidth and a certain number of resource blocks in a state in which the modulation scheme is 16 QAM (Quadrature Amplitude Modulation) corresponds to sequence 1 or sequence 2.

The scheduling parameters of the same sequence may be mapped to the same amount or range of the PC, and scheduling parameters belonging to different sequences may be mapped to different amounts or ranges of PC. Namely, a sequence denotes an aggregate of scheduling parameters mapped to the same amount or range of PC. A PC table maps a sequence of predefined communication environment to the amount or range of PC. Table 2 shows an example thereof.

TABLE 2

| | | Channel bandwidth/ | | | | | | |
|---|---|---|---|---|---|---|---|---|
| Scheduling | | Transmission bandwidth configuration (RB) | | | | | | PC |
| Parameter | Modulation | 1.4 MHz | 3.0 MHz | 5 MHz | 10 MHz | 15 MHz | 20 MHz | (dB) |
| Sequence 0 | QPSK | >5 | >4 | >8 | >12 | >16 | >18 | ≦1 |
| Sequence 1 | 16 QAM | ≦5 | ≦4 | ≦8 | ≦12 | ≦16 | ≦18 | ≦2 |
| Sequence 2 | 16 QAM | >5 | >4 | >8 | >12 | >16 | >18 | ≦3 |

With reference to Table 2, the scheduling parameter corresponding to sequence 0 is mapped to the amount of PC within a range of 1 dB or lower, the scheduling parameter corresponding to sequence 1 is mapped to the amount of PC within a range of 2 dB or lower, and the scheduling parameter corresponding to sequence 2 is mapped to the amount of PC within a range of 3 dB or lower.

For example, among scheduling parameters belonging to sequence, when a scheduling parameter of 16 QAM modulation and 18 RB with respect to an MS in a 20 MHz system is assumed, a maximum value of the PC amount of the corresponding MS is up to 2 dB. Thus, the MS may be designed such that the set maximum transmission power is reduced to 2 dB. The MS is to be designed to satisfy PC of a certain amount or range under the respective sequences of Table 2. The reason why the PC amount has the characters of requirements is because the PC amount may be different set for each MS according to an implementation form of each MS or the characteristics of a power amplifier. For example, a power coordination amount of a high-end MS is not much changed according to a change in the scheduling parameter, but a low-end MS may experience a great change of power coordination amount.

The number of sequences may be changed according to the number of CCs configured in the MS or the number of RFs used for uplink transmission. For example, when one CC is set and one RF is used in Table 2, Table 3 below shows a case in which two CCs are set and one RF is used.

TABLE 3

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | 1 ≦ x ≦ 2 |
| Sequence 1 | QPSK, 16QAM | >5, <5 | >4, <4 | >8, <8 | >12, <12 | >16, <16 | >18, <18 | 1 ≦ x ≦ 2 |
| Sequence 2 | QPSK, 16QAM | >5, >5 | >4, >4 | >8, >8 | >12, >12 | >16, >16 | >18, >18 | 2 ≦ x ≦ 3 |
| Sequence 3 | 16QAMx2 | <5, <5 | <4, <4 | <8, <8 | <12, <12 | <16, <16 | <18, <18 | 1 ≦ x ≦ 2 |
| Sequence 4 | 16QAMx2 | >5, <5 | >4, <4 | >8, <8 | >12, <12 | >16, <16 | >18, <18 | 2 ≦ x ≦ 3 |
| Sequence 5 | 16QAMx2 | >5, >5 | >4, >4 | >8, >8 | >12, >12 | >16, >16 | >18, >18 | 3 ≦ x ≦ 5 |

In Table 3, x indicates the range of PC. When the number of CCs and the number of RFs are determined, a new sequence can be generated accordingly. Such a sequence is a factor determined by a unique specification of an MS, so the sequences of each MS and the amount of range of PC mapped to the respective sequences may be different, and only each MS knows about the information. Meanwhile, the BS cannot know about the respective sequences defined in each MS and the amount or range of PC mapped to the respective sequences. Thus, each MS must provide information regarding PC to the BS. Table 4 shows an example of information regarding PC.

TABLE 4

| | |
|---|---|
| UE-PC information | SEQUENCE (SIZE (1...maxSQ_index)){ |
| SQ_index | Integer {0 ... 31} |
| PCValue_Low | Integer {0 ... 10} |
| PCValue_High | Integer {0 ... 10} |
| PC_Offset | Integer {0 ... 10} |

With reference to FIG. 4, UE-PC information refers to information regarding UE-specific PC. The sequence index (SQ_index) is an index for discriminating each sequence and is an integer from 0 to 31, and here, 31 corresponds to a maximum sequence index (maxSQ_index). The size of a sequence is variable from 1 to the maximum sequence index. The lowest PC value (PCValue_Low) is the lowest value of PC applied to an MS, and the highest PC value (PCValue_High) is the highest value of PC applied to the MS. A PC offset (PC_offset) is an amount or a range (dB) of PC constantly set irrespective of MS scheduling.

When a PC value is not defined as a range value, one PC value may be included instead of the lowest PC value (PCValue_Low) and the highest PC value (PCValue_High). The sequence size, the lowest value, the highest value, or the PC value are not necessarily defined as shown in Table 4 and those of Table 4 are merely illustrative. Thus, the technical concept of the present invention is not limited.

For example, when two CCs are configured in an MS and one RF is supported, it is assumed that sequences are set as shown in Table 3. It is also assumed that scheduling parameters determined by the BS for CC1 and CC2 are all QPSK, 20 MHz, and 20 RB. This corresponds to sequence 0. Thus, information regarding PC is configured as shown in Table 5 below to indicate sequence index 0 indicating sequence 0 and a range of PC, 1≦x≦2, mapped to sequence 0.

TABLE 5

| | |
|---|---|
| UE-PC information | SEQUENCE (SIZE (6){ |
| SQ_index = 0 | |
| PCValue_Low = 1 | |
| PCValue_High = 2 | |
| PC_Offset = 0 | |
| } | |

Since sequences 0 to 5 exist, the size of the sequences is 6, index (SQ_index)=0, lowest PC value (PCValue_Low)=1 dB, highest PC value (PCValue_High)=2 dB, and PC offset=0 dB.

A communication environment frequently changed over time. For example, a scheduling parameter allocated by the BS to the MS may be changed. In this case, the MS transmits a sequence index corresponding to the changed scheduling parameter and information regarding PC including the amount or range of PC.

In another example, the number of CCs set by the BS in the MS or the number of RFs applied to the MS may be changed. A new sequence according to the changed number of CCs and the changed number of RFs is automatically determined to include all the number of cases of the scheduling parameter. Namely, the MS and the BS know about the new sequence. What the BS does not know about is the amount or range of PC determined to be specific to the MS with respect to the new sequence. Thus, the MS transmits the sequence index corresponding to the scheduling parameter allocated by the BS to the MS and the information regarding PC including the amount or range of PC to the BS.

In this manner, whenever the communication environment such as the scheduling parameter, the number of CCs, and the number of RFs, are changed, the MS transmits the new sequence index and the information regarding PC including the amount or range of PC to the BS, whereby the BS can effectively perform uplink scheduling.

(2) In another example, the information regarding PC is an index indicating a PC table which maps a sequence of predefined communication environment to the amount or range of PC. The PC table is defined differently by MS according to its specification. Namely, the amount or range of PC mapped to a sequence in a PC table for an MS is different from the amount or range of PC mapped to the same sequence in another PC table for another MS.

Or, the PC table is defined by the number of CCs configured in the MS and the number of radio frequency chains applied to the MS.

Table 6 to Table 8 below show examples of PC tables defined in a communication environment Case1 in which the number of aggregatable CCs of the MS totals 2 and the number of supportable RF is 1.

TABLE 6

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | 3 ≦ x ≦ 4 |
| Sequence 1 | QPSK, 16QAM | >5, ≦5 | >4, ≦4 | >8, ≦8 | >12, ≦12 | >16, ≦16 | >18, ≦18 | 3 ≦ x ≦ 4 |
| Sequence 2 | QPSK, 16QAM | >5, >5 | >4, >4 | >8, >8 | >12, >12 | >16, >16 | >18, >18 | 5 ≦ x ≦ 6 |
| Sequence 3 | 16QAMx2 | ≦5, ≦5 | ≦4, ≦4 | ≦8, ≦8 | ≦12, ≦12 | ≦16, ≦16 | ≦18, ≦18 | 3 ≦ x ≦ 4 |
| Sequence 4 | 16QAMx2 | >5, ≦5 | >4, ≦4 | >8, ≦8 | >12, ≦12 | >16, ≦16 | >18, ≦18 | 5 ≦ x ≦ 6 |
| Sequence 5 | 16QAMx2 | >5, >5 | >4, >4 | >8, >8 | >12, >12 | >16, >16 | >18, >18 | 8 ≦ x ≦ 10 |

TABLE 7

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | 1 ≦ x ≦ 2 |
| Sequence 1 | QPSK, 16QAM | >5, ≦5 | >4, ≦4 | >8, ≦8 | >12, ≦12 | >16, ≦16 | >18, ≦18 | 1 ≦ x ≦ 2 |
| Sequence 2 | QPSK, 16QAM | >5, >5 | >4, >4 | >8, >8 | >12, >12 | >16, >16 | >18, >18 | 2 ≦ x ≦ 3 |
| Sequence 3 | 16QAM x2 | ≦5, ≦5 | ≦4, ≦4 | ≦8, ≦8 | ≦12, ≦12 | ≦16, >16 | ≦18, ≦18 | 1 ≦ x ≦ 2 |
| Sequence 4 | 16QAM x2 | >5, ≦5 | >4, ≦4 | >8, ≦8 | >12, ≦12 | >16, ≦16 | >18, ≦18 | 2 ≦ x ≦ 3 |
| Sequence 5 | 16QAM x2 | >5, >5 | >4, >4 | >8, >8 | >12, >12 | >16, >16 | >18, >18 | 4 ≦ x ≦ 5 |

TABLE 8

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | 0 ≦ x ≦ 1 |
| Sequence 1 | QPSK, 16QAM | >5, ≦5 | >4, ≦4 | >8, ≦8 | >12, ≦12 | >16, ≦16 | >18, ≦18 | 0 ≦ x ≦ 1 |
| Sequence 2 | QPSK, 16QAM | >5, >5 | >4, >4 | >8, >8 | >12, >12 | >16, >16 | >18, >18 | 1 ≦ x ≦ 2 |
| Sequence 3 | 16QAM x2 | ≦5, ≦5 | ≦4, ≦4 | ≦8, ≦8 | ≦12, ≦12 | ≦16, ≦16 | ≦18, ≦18 | 0 ≦ x ≦ 1 |
| Sequence 4 | 16QAM x2 | >5, ≦5 | >4, ≦4 | >8, ≦8 | >12, ≦12 | >16, ≦16 | >18, ≦18 | 0 ≦ x ≦ 1 |
| Sequence 5 | 16QAM x2 | >5, >5 | >4, >4 | >8, >8 | >12, >12 | >16, >16 | >18, >18 | 2 ≦ x ≦ 3 |

Table 6 to Table 8 are PC tables, showing that there may be one or more PC tables having the same sequence in a communication environment based on the same number of CCs and the same number of RFs. However, these are characterized by the fact that the amounts or ranges of PC mapped to the same sequence are different. Namely, the respective sequences of Table 6 to Table 8 are all the same, but the amounts or ranges of PC mapped to the respective sequences are different. For example, in case of sequence 0, the range of PC mapped to sequence 0 in Table 6 is 3≦x≦4, the range of PC mapped to sequence 0 in Table 7 is 1≦x≦2, and the range of PC mapped to sequence 0 in Table 8 is 0≦x≦1.

The PC tables of Table 6 to Table 8 are indicated by PC table indexes 0, 1, and 2, respectively. The MS transmits an index of a PC table corresponding to its specification to the BS. Accordingly, the number of bits of the information regarding PC is expressed by Math FIG. 8 shown below in order to indicate every PC table index.

N_{PC-info}=Celing[log₂(MAX(N_{Case1}, N_{Case2}, . . . , N_{CaseM}))] [Math Figure 8]

Here, N_{PC-info} is the number of bits of the information regarding PC, Ceiling[a] is a minimum integer greater than ‘a’, MAX(a, b, c, . . . , z) is the largest integer among a, b, c, . . . , z, CaseM is a communication environment M formed by the combination of the number of different CCs and the number of RFs, and N_{caseM} is the number of PC tables which may exist in the communication environment M.

For example, Table 6 to Table 8 may be PC tables existing in Case1, and Table 9 to Table 11 may be PC tables existing in Case2, and Table 12 below may be a PC table existing in Case3. Here, N_{case1}=3, N_{case2}=3, and N_{case3}=1. However, this is merely illustrative, and the values of N_{case1}, N_{case2}, and N_{case3} may be different. In this manner, at least one PC table exists for each of the communication environment cases, and the respective PC tables may be discriminated by a PC table index.

Here, the fact that the information regarding PC is index information is on the premise that the BS and the MS already know about the PC tables. In this case, the MS and the BS should have the PC tables of all the cases supported in the system and indexes of the respective PC tables stored in a memory. When the MS transmits an index of a particular PC table to the BS, the BS may select the PC table of the corresponding index stored in the memory to know about the amount or range of PC of the MS. Since the PC table itself is not transmitted and only the index information is used, control resource required for transmitting information regarding PC can be reduced.

Table 6 to Table 8 are PC tables in case in which the number of aggregatable CCs of the MS totals 2, and at least one PC table including a new sequence when the number of CCs is changed may exist. For example, in case of communication environment Case2 in which the number of aggregatable CCs of the MS totals 2, the PC tables in Table 9 to Table 11 below may exist.

TABLE 9

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | ≦2 |
| Sequence 1 | QPSK, 16QAM | >5, ≦5 | >4, ≦4 | >8, ≦8 | >12, ≦12 | >16, ≦16 | >18, ≦18 | 3 ≦ x ≦ 5 |
| Sequence 2 | QPSK, 16QAM | >5, >5 | >4, >4 | >8, >8 | >12, >12 | >16, >16 | >18, >18 | 5 ≦ x ≦ 7 |
| Sequence 3 | 16QAM x2 | ≦5, ≦5 | ≦4, ≦4 | ≦8, ≦8 | ≦12, ≦12 | ≦16, ≦16 | ≦18, ≦18 | 5 ≦ x ≦ 7 |
| Sequence 4 | 16QAM x2 | >5, ≦5 | >4, ≦4 | >8, ≦8 | >12, ≦12 | >16, ≦16 | >18, ≦18 | 7 ≦ x ≦ 9 |
| Sequence 5 | 16QAM x2 | >5, >5 | >4, >4 | >8, >8 | >12, >12 | >16, >16 | >18, >18 | 9 ≦ x ≦ 11 |

TABLE 10

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | ≦1 |
| Sequence 1 | QPSK, 16QAM | >5, ≦5 | >4, ≦4 | >8, ≦8 | >12, ≦12 | >16, ≦16 | >18, ≦18 | 1 ≦ x ≦ 2 |
| Sequence 2 | QPSK, 16QAM | >5, >5 | >4, >4 | >8, >8 | >12, >12 | >16, >16 | >18, >18 | 3 ≦ x ≦ 4 |
| Sequence 3 | 16QAM x2 | ≦5, ≦5 | ≦4, ≦4 | ≦8, ≦8 | ≦12, ≦12 | ≦16, ≦16 | ≦18, ≦18 | 3 ≦ x ≦ 4 |
| Sequence 4 | 16QAM x2 | >5, ≦5 | >4, ≦4 | >8, ≦8 | >12, ≦12 | >16, ≦16 | >18, ≦18 | 3 ≦ x ≦ 5 |
| Sequence 5 | 16QAM x2 | >5, >5 | >4, >4 | >8, >8 | >12, >12 | >16, >16 | >18, >18 | 4 ≦ x ≦ 6 |

TABLE 11

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | ≦1 |
| Sequence 1 | QPSK, 16QAM | >5, ≦5 | >4, ≦4 | >8, ≦8 | >12, ≦12 | >16, ≦16 | >18, ≦18 | ≦1 |
| Sequence 2 | QPSK, 16QAM | >5, >5 | >4, >4 | >8, >8 | >12, >12 | >16, | >16 >18, >18 | ≦2 |
| Sequence 3 | 16QAM x2 | ≦5, ≦5 | ≦4, ≦4 | ≦8, ≦8 | ≦12, ≦12 | ≦16, ≦16 | ≦18, ≦18 | ≦2 |
| Sequence 4 | 16QAM x2 | >5, ≦5 | >4, ≦4 | >8, ≦8 | >12, ≦12 | >16, ≦16 | >18, ≦18 | ≦2 |
| Sequence 5 | 16QAM x2 | >5, >5 | >4, >4 | >8, >8 | >12, >12 | >16, >16 | >18, >18 | ≦2 |

The PC tables of Table 9 to Table 11 may be indicated by PC table indexes 0, 1, and 2, respectively.

Meanwhile, in case of communication environment Case3 in which the number of aggregatable CCs of the MS totals 5, the PC table in Table 12 may exist.

TABLE 12

| | | Channel bandwidth/Transmission bandwidth | | | | | | |
|---|---|---|---|---|---|---|---|---|
| Scheduling | | configuration (RB) | | | | | | PC |
| Parameter | Modulation | 1.4 MHz | 2.5 MHz | 5 MHz | 10 MHz | 15 MHz | 20 MHz | (dB) |
| Sequence 0 | QPSK, QPSK, QPSK, QPSK, | >5, >5, | >4, >4, | >8, | >12, >12, | >16, >16, | >18, | ≦2 |
| | QPSK | >5, | >4, | >8, | >12, | >16, | >18, | |
| | | >5, | >4, | >8, | >12, | >16, | >18, | |
| | | >5 | >4 | >8, | >12 | >16 | >18, | |
| | | | | >8 | | | >18 | |
| Sequence 1 | QPSK, QPSK, QPSK, QPSK, | >5, >5, | , >4, | , >8, | >12, >12, | >16, >16, | >18, | 2 ≦ x ≦ 4 |
| | 16QAM | >5, | >4, | >8, | >12, | >16, | >18, | |
| | | >5, | >4, | >8, | >12, | >16, | >18, | |
| | | >5 | >4 | >8 | >12 | >16 | >18, | |
| | | | | | | | >18 | |
| . . . | . . . | . . . | . . . | . . . | . . . | . . . | . . . | . . . |
| Sequence L | 16QAM x5 | >5, >5, | 4, >4, | >8, | >12, >12, | >16, >16, | >18, | 10 ≦ x ≦ 12 |
| | | >5, | >4, | >8, | >12, | >16, | >18, | |
| | | >5, | >4 | >8, | >12, | >16, | >18, | |
| | | >5 | | >8 | >12 | >16 | >18, | |
| | | | | | | | >18 | |

With reference to Table 12, only one the PC table exists, and a PC table index is 0. Also, the sequences constituting the PC table is L+1.

The PC table indexes of Table 6 to Table 8 are 0, 1, and 2, respectively, the PC table indexes of Table 9 to Table 1 are also 0, 1, and 2, respectively, and the PC table index of Table 12 is 0, so all the PC table indexes are repeated. However, when the BS receives a PC table index, it can accurately find out a corresponding PC table. This is because, since the BS directly sets CCs for the MS, the BS already has the information regarding the number of CCs currently configured in the MS. For example, when the BS sets two CCs in the MS, the BS can recognize that the PC tables of Table 6 to Table 8 according to Case1 are applied to the MS. In this case, when the BS receives the PC table index 0 from the MS, the BS performs uplink scheduling based on the PC table of Table 6, and when the BS receives the PC table index 1 from the MS, the BS performs uplink scheduling based on the PC table of Table 7.

(3) In another example, information regarding PC includes communication environment information. The communication environment information is a parameter exhibiting hardware characteristics regarding PC, which includes power class, the number of supportable transmission and reception RFs, and the number of aggregatable CCs of the MS. A PC table can be specified by the communication environment information. For example, it is assumed that information regarding PC is configured as shown in Table 13 below.

TABLE 13
Information regarding PC

| | |
|---|---|
| Powerclass | 3 |
| RF | 2 |
| Aggregatable CC | 5 |

Since the power class of the MS is 3, the supportable RFs is 2, and aggregatable CCs is 5, the PC table of Table 2 can be specified. Here, the MS and the BS should have PC tables of all the cases stored in the memory. When the MS provides to the BS the information regarding PC configured with communication environment information, the BS may select a PC table specified by the information elements from among all the PC tables stored in the memory and performs uplink scheduling.

(4) In another example, information regarding PC may be configured in the format including communication environment information and a PC table index. Since at least one PC table may exist according to communication environment information, the MS can find out the communication environment information and a corresponding PC table. For example, the communication environments of Table 6 to Table 12 are assumed. The MS informs the BS the fact that power class of the MS is 3 and the number of RF chains used for supporting a current multi-component carrier environment is 2, as information regarding PC. Accordingly, the BS can recognize that the communication environment in which the MS operates based on the current multi-component carrier environment is Case3. When the total number of PC tables within the communication environment Case3 is 10 and a table selected to be used by the MS from among the 10 PC tables is the tenth PC table, the MS includes information of PC table index=10, along with the communication environment information, in the information regarding PC, and transmits the same to the BS.

3. Transmission of Information Regarding PC

The BS may reconfigure an RRC connection by perform an RRC connection reconfiguration procedure with the MS in the RRC connected mode in the following situation.
Configuration, change, or release of radio bearer (RB)
Handover
Configuration, change, or release of measurement
When the BS performs a procedure of transferring NAS (Non-Access Strartum dedicated) information to the MS.

When the RRC connection is reconfigured, the BS may change the existing communication environment, such as the number of CCs configured in the MS. Thus, when a new communication environment is established by the RRC connection reconfiguration, the MS may have a changed sequence and PC table which correspond with the new communication environment. In this case, the MS should transmit to the BS the amount or range of PC mapped to the changed sequence. Here, the MS may include information regarding PC in an RRC connection reconfiguration complete message and transmit the same to the BS. Hereinafter, a method for transmitting, by the MS, information regarding PC according to an RRC signaling procedure will be described in detail.

FIG. 10 is a flow chart illustrating a process of a method for transmitting information regarding PC in a multi-component carrier system according to an embodiment of the present invention.

With reference to FIG. 10, the MS transmits information regarding PC to the BS (S1000). As described above, the information regarding PC may be information in the form of directly or explicitly describing the amount or range of PC required for the MS to which a scheduling parameter has been allocated. Or the information regarding PC may be an index indicating a PC table which maps a sequence defined by a communication environment to an amount or range of PC. Or the information regarding PC may be information configured as communication environment information. Or the information regarding PC may be information configured in the format including communication environment information and a PC table index.

The BS performs uplink scheduling with reference to the PC table determined based on the information regarding PC (S1005). Here, the uplink scheduling may determine a modulation scheme not exceeding the maximum transmission power of the MS based on the range of amount of PC on the PC table referred to and resource blocks to be allocated.

The BS transmits an uplink grant based on the uplink scheduling to the MS (S1010). The uplink grant is downlink control information (DCI) of a format 0 for an uplink resource allocation with respect to the MS, which is transmitted on a PDCCH. The uplink grant may be configured as shown in Table 14 below.

[Table 14]
Flag for format0/format1A differentiation—1 bit, where value 0 indicates format 0 and value 1 indicates format 1A
Frequency hopping flag—1 bit
Resource block assignment and hopping resource allocation—┌log₂(N_{RB}^{UL}(N_{RB}^{UL}+1)/2)┐ bits
   For PUSCH hopping:
      N_{UL}_{_{—}}ₕₒₚ MSB bits are used to obtain the value of ñ_{PRB}(i)
      (┌log₂(N_{RB}^{UL}(N_{RB}^{UL}+1)/2)┐−N_{UL}_{_{—}}ₕₒₚ) bits provide the resource allocation of the first slot
      in the UL subframe
For non-hopping PUSCH:
   (┌log₂(N_{RB}^{UL}(N_{RB}^{UL}+1)/2)┐) bits provide the resource allocation in the UL subframe
Modulation and coding scheme and redundancy version—5 bits
New data indicator—1 bit
TPC command for scheduled PUSCH—2 bits
Cyclic shift for DM RS—3 bits
UL index—2 bits (this field is present only for TDD operation with uplink-downlink configuration 0)
   Downlink Assignment Index (DAI)—2 bits (this field is present only for TDD operation with uplink-downlink configurations 1-6)
CQI request—1 bit
Carrier Index Field (CIF)—3 bits (this field is present only for Carrier Aggregation)

With reference to Table 14, the uplink grant includes information regarding RB, modulation and coding scheme (MCS), TPC, and the like. The MS transmits uplink data generated based on the number of RBs, MCS, TPC, and the like, included in the uplink grant to the BS (S1015).

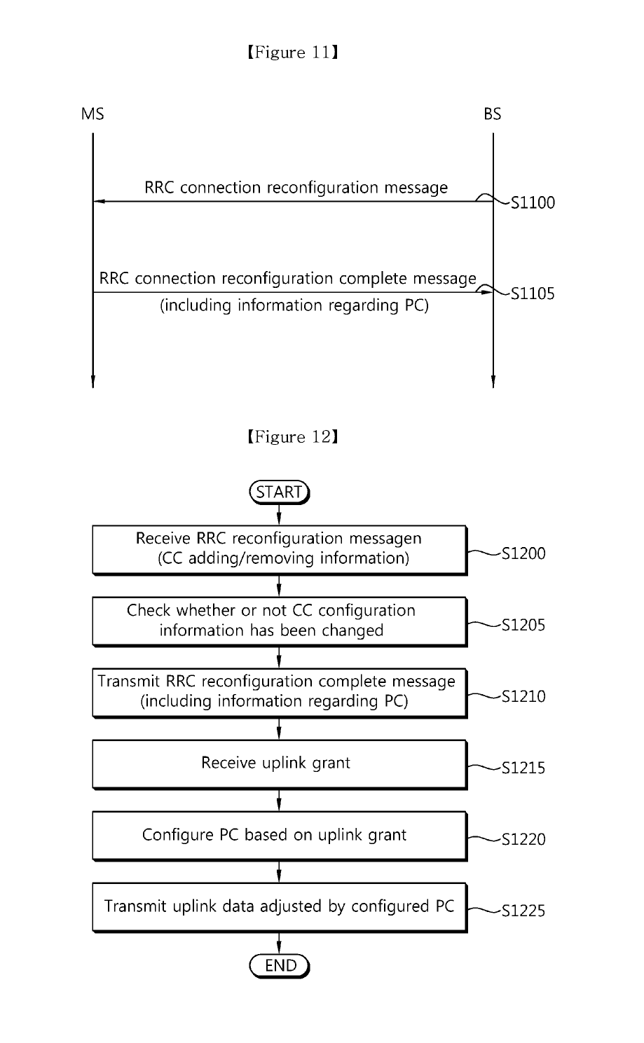

FIG. 11 is a flow chart illustrating a process of a method for transmitting information regarding PC in a multi-component carrier system according to another embodiment of the present invention.

With reference to FIG. 11, the BS transmits an RRC connection reconfiguration message including information regarding PC to the MS (S1100). In this case, the MS performs a detailed CC reconfiguration procedure such as adding, modifying, or releasing of a CC with respect to the corresponding MS by using CC configuration information included in the RRC connection reconfiguration message received from the BS. Here, the procedure of adding, modifying, and releasing of a CC is performed upon checking a list including one or more CCs for performing the corresponding procedure.

Thereafter, the MS adds, modifies, or releases configuration parameters required for wireless communication with the BS. And the MS generates an RRC connection reconfiguration complete message, and transmits the same to the BS (S1105).

As described above, the information regarding PC may be information in the form of directly or explicitly describing the amount or range of PC required for the MS to which a scheduling parameter has been allocated. Or the information regarding PC may be an index indicating a PC table which maps a sequence based on a communication environment to the amount or range of PC. Or the information regarding PC may be information configured as communication environment information. Or the information regarding PC may be information configured in the format including communication environment information and a PC table index.

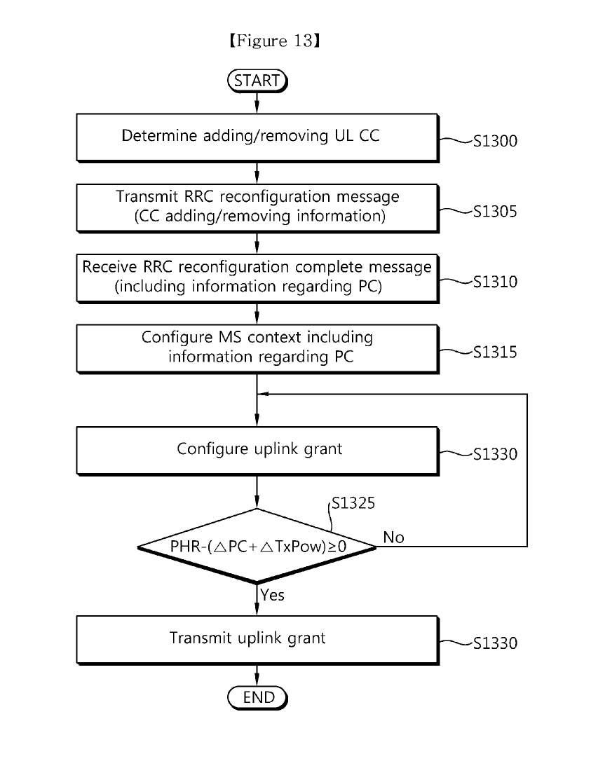

In this manner, the information regarding PC can be transmitted by making use of the RRC connection establishment procedure, and accordingly, a RRC-related message newly has a structure including the information regarding PC. Hereinafter, the operation of the MS and the BS performing the RRC connection establishment procedure to transmit or receive the information regarding PC will now be described with reference to FIGS. 12 and 13.

FIG. 12 is a flow chart illustrating a process of a method for transmitting information regarding power coordination by the MS in a multi-component carrier system according to an embodiment of the present invention.

With reference to FIG. 12, the MS receives an RRC reconfiguration message from the BS (S1200). The RRC reconfiguration message may include CC configuration information. The CC configuration information may include one or more of unique information of each CC and CC index information matched to the unique information of each CC. The CC index information refers to any type of data or information matched to unique information of each CC so as to be used as an indicator discriminating a corresponding CC. Namely, the CC index information is indication information with respect to a CC set to discriminate the CC in a physical layer on an RRC message.

The MS checks whether or not there is a message related to a change in a CC setting in the RRC reconfiguration message (S1205). For example, the message related to the change in a CC setting may include adding, removing, or modifying of a CC.

The MS completes the RRC reconfiguration according to the RRC reconfiguration message, and transmits an RRC reconfiguration complete message including information regarding PC to the BS (S1210). The RRC reconfiguration complete message including information regarding PC is as shown in Table 15 below.

TABLE 15
RRCConnectionReconfigurationComplete {

| | |
|---|---|
| Critical Extensions | |
| UE-PC information | SEQUENCE (SIZE (1..maxSQ_index)) { |
| SQ_index | Integer {0... 31} |
| PCValue_Low | Integer {0... 10} |
| PCValue_High | Integer {0... 10} |
| PC_offset | Integer {0... 10} |
| } | |

Non-Critical Extensions

Here, Critical Extensions is information to be essentially transmitted for an existing function of the RRC reconfiguration complete message. UE-PC information is an example of information regarding PC according to Table 4 above. Of course, the format of UE-PC information may be an index indicating a PC table which maps a sequence based on a communication environment to the amount or range of PC. Or the format of UE-PC information may be information configured as communication environment information. Or the format of UE-PC information may be information configured in the format including communication environment information and a PC table index, as well as Table 4 above.

The MS receives an uplink grant for transmission of uplink data from the BS (S1215). The MS sets a PC amount in a corresponding subframe based on the uplink grant (S1220).

The MS adjusts maximum transmission power in consideration of the set PC amount, sets uplink transmission power, and transmits uplink data to the BS (S1225).

FIG. 13 is a flow chart illustrating a process of a method for receiving information regarding power coordination by the BS in a multi-component carrier system according to an embodiment of the present invention.

With reference to FIG. 13, the BS calculates uplink resource required for the MS in consideration of a scheduling request (SR) received from the MS, buffer state report (BSR) information, or the like. Also, the BS determines the number of UL CCs to be allocated to the MS and a combination of UL CCs in consideration of the resource currently available in the BS, a network policy, or the like (S1300). The combination of UL CCs refers to an aggregate of selected CCs. For example, when the number of UL CCs to be allocated to the MS is 3 and there are first to fifth UL CCs, the combination of UL CCs allocated to the MS may be configured by selecting three UL CCs among five UL CCs such as {1,2,3} or {1,3,5}.

When the number and combination of UL CCs are changed, the BS generates an RRC connection reconfiguration message in consideration of the change, and transmits the RRC connection reconfiguration message to the MS (S1305).

The BS receives an RRC connection reconfiguration complete message including the information regarding PC from the MS in response to the RRC connection reconfiguration message (S1310). The information regarding PC may be information in the form of directly or explicitly describing the amount or range of PC required for the MS to which a scheduling parameter has been allocated. Or the information regarding PC may be index information indicating a PC table which maps a sequence based on a communication environment to an amount or range of PC. Or the information regarding PC may be information configured as communication environment information. Or the information regarding PC may be information configured in the format including communication environment information and a PC table index.

Since the BS has included the information regarding adding/modifying/removing of a CC in the RRC connection reconfiguration message and transmitted, it checks information regarding PC transmitted from the MS and configures MS context of the MS including the information regarding PC (S1315).

The BS configures an uplink grant with respect to the MS based on the information regarding PC (S1320). The BS determines scheduling validity (S1325). Here, determination of scheduling validity refers to determining, by the BS, whether or not a changed scheduling parameter is valid in terms of uplink maximum transmission power based on the power headroom report (PHR) last received by the BS when the scheduling parameter, which affects an estimated power coordination value, is changed.

An example of determination of scheduling validity is as shown in Math Figure 9 below:

PHR−(ΔEPC−ΔTxPw)≧0 [Math Figure 9]

With reference to Math Figure 9, ΔEPC is a value obtained by subtracting an estimated power coordination (EPC) value estimated based on a previous scheduling parameter from an EPC value estimated based on a current scheduling parameter. The scheduling parameters affecting the EPC value include the number of resource blocks, a modulation scheme, a PUSCH resource allocation form (whether or not resource is allocated continuously or discontinuously), whether or not the PUCCH exists (whether or not PUCCH and PUSCH are transmitted in parallel or whether or not PUSCH is transmitted alone), and the like.

Meanwhile, ΔTxPw=ΔPUSCH+ΔPUCCH. Here, ΔPUCCH is considered only in case of a major cell. ΔPUSCH is a value obtained by subtracting power of the last scheduled PUSCH from power of PUSCH calculated according to a current scheduling parameter. ΔPUCCH is a value obtained by subtracting power of the last received PUCCH from power of PUCCH to be received through major cells in a corresponding sub-frame. Here, since the PUCCH is received through major cells of the MS according to a period set for each MS by the BS, the BS can estimate whether or not the PUCCH has been received according to subframes.

When the determination of scheduling validity is made by Math Figure 9, if Math FIG. 9 is false, the scheduling parameter is configured such that ΔEPC or ΔTxPw is reduced according to the policy of the corresponding BS (S1320).

If Math Figure 9 is true, since the configured scheduling parameter is valid, the BS transmits the configured uplink grant to the MS (S1330).

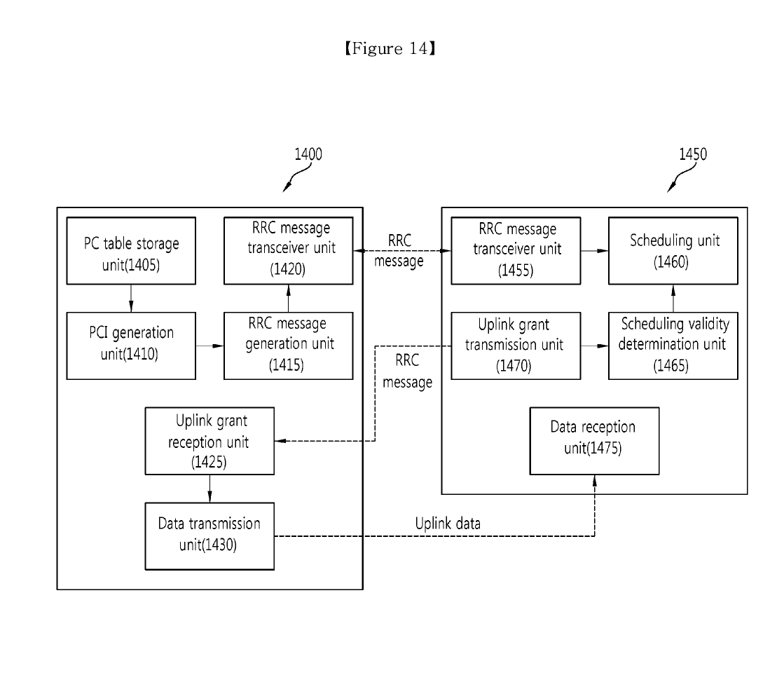

FIG. 14 is a schematic block diagram showing an apparatus for transmitting information regarding power coordination and an apparatus for receiving information regarding power coordination in a multi-component carrier system according to an embodiment of the present invention.

With reference to FIG. 14, an apparatus 1400 for transmitting information regarding power configuration (will be referred to as a power coordination information (PCI) transmission apparatus, hereinafter) includes a PC table storage unit 1405, a PCI generation unit 1410, an RRC message generation unit 1415, an RRC message transceiver unit 1420, an uplink (UL) grant reception unit 1425, and a data transmission unit 1430. The PCI transmission apparatus 1400 may be part of the MS.

The PC table storage unit 1405 stores a PC table. Examples of PC tables are as shown in Table 6 to Table 12.

The PCI generation unit 1410 generates information regarding PC. The information regarding PC may be information providing an amount or a range of PC specified according to various communication environments to the BS, which can be configured as the embodiments of (1), (2), (3), and (4).

The RRC message generation unit 1415 generates an RRC message including information regarding PC. For example, the RRC message generation unit 1415 generates an RRC connection reconfiguration complete message including information regarding PC. The RRC connection reconfiguration complete message additionally includes information regarding PC as well as content of the original RRC connection reconfiguration complete message.

The RRC message transceiver unit 1420 transmits an RRC message including information regarding PC to an apparatus 1450 for receiving information regarding PC (will be referred to as a power coordination information (PCI) reception apparatus 1450, hereinafter).

The uplink grant reception unit 1425 receives an uplink grant from the PCI reception apparatus 1450 of the information regarding PC. Table 16 shows an example of the uplink grant.

[Table 16]
Flag for format0/format1A differentiation—1 bit, where value 0 indicates format 0 and value 1 indicates format 1A
Frequency hopping flag—1 bit
Resource block assignment and hopping resource allocation—┌log₂(N_{RB}^{UL}(N_{RB}^{UL}+1)/2)┐ bits
   For PUSCH hopping:
      N_{UL}_{_{—}}ₕₒₚ MSB bits are used to obtain the value of ñ_{PRB}(i)
         (┌log₂(N_{RB}^{UL}(N_{RB}^{UL}+1)/2)┐−N_{UL}_{_{—}}ₕₒₚ) bits provide the resource allocation of the first slot in the UL subframe
For non-hopping PUSCH:
   (┌log₂(N_{RB}^{UL}(N_{RB}^{UL}+1)/2)┐) bits provide the resource allocation in the UL subframe
Modulation and coding scheme and redundancy version—5 bits
New data indicator—1 bit
TPC command for scheduled PUSCH—2 bits
Cyclic shift for DM RS—3 bits
UL index—2 bits (this field is present only for TDD operation with uplink-downlink configuration 0)
   Downlink Assignment Index (DAI)—2 bits (this field is present only for TDD operation with uplink-downlink configurations 1-6)
CQI request—1 bit
Carrier Index Field (CIF)—3 bits (this field is present only for Carrier Aggregation)

The data transmission unit 1430 transmits uplink data based on a scheduling parameter according to the received uplink grant and information regarding PC to the PCI reception apparatus 1450.

The PCI reception apparatus 1450 includes an RRC message transceiver unit 1455, a scheduling unit 1460, a scheduling validity determination unit 1465, an uplink grant transmission unit 1470, and a data reception unit 1475. The PCI reception apparatus 1450 may be part of the BS.

The RRC message transceiver unit 1455 transmits a RRC connection reconfiguration message including CC configuration information for adding/modifying a CC to the PCI transmission apparatus 1400 or receives an RRC connection reconfiguration complete message including the information regarding PC from the PCI transmission apparatus 1400.

The scheduling unit 1460 sets scheduling parameters such as MCS, TPC, resource allocation information, and the like, with respect to the PCI transmission apparatus 1400 in consideration of a channel situation, a buffer state report, a network situation, a resource usage situation, and the like, of the PCI transmission apparatus 1400.

When a scheduling parameter affecting estimated power coordination value is changed by the scheduling unit 1460, the scheduling validity determination unit 1465 determines whether or not the changed scheduling parameter is valid in terms of uplink maximum transmission power based on the PHR finally received by the PCI reception apparatus 1450. An example of determination of scheduling validity is performed by Math Figure 9 shown above.

The uplink grant transmission unit 1470 configures an uplink grant based on the scheduling parameter determined to be valid according to the determination results of scheduling validity, and transmits the configured uplink grant to the PCI information transmission apparatus 1400.

The data reception unit 1475 receives uplink data from the PCI information transmission apparatus 1400.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

1. A method for transmitting information regarding power coordination by a mobile station (MS) in a multi-component carrier system, the method comprising:
setting information regarding power coordination (PC) indicating an amount or a range of power which is used to adjust uplink maximum transmission power of the MS; and
transmitting the information regarding PC to a base station (BS), wherein the information regarding PC is varied according to the number of component carriers configured in the MS.

2. The method of claim 1, further comprising:
receiving, from the BS, a radio resource control (RRC) connection re-configuration message including a component carrier (CC) con-figuration information configured in the MS.

3. The method of claim 1, wherein the information regarding PC is transmitted to the BS through an RRC connection reconfiguration complete message as a response to the RRC connection reconfiguration message.

4. The method of claim 1, wherein the information regarding PC includes an index indicating a sequence and information indicating the amount or range of PC mapped to the sequence, the sequence is an aggregate of scheduling parameters mapped to the same amount or range of PC, and a scheduling parameter is determined by the combination of a modulation and coding scheme (MCS) applied to uplink transmission of the MS and the number of resource blocks allocated to the uplink transmission of the MS.

5. The method of claim 1, wherein the information regarding PC is an index indicating at least one PC table defined by the combination of the number of CCs configured in the MS and the number of radio frequency (RF) chains applied to the MS, wherein the at least one PC table includes a sequence which is an aggregate of scheduling parameters mapped to the same amount or range of PC.

6. The method of claim 1, wherein the information regarding PC is determined by the number of RFs supported for the MS and the number of aggregatable CCs of the MS.

7. A method for receiving information regarding power coordination (PC) by a BS in a multi-component carrier system, the method comprising:
receiving, from a mobile station (MS), information regarding PC indicating an amount or a range of power which is used to adjust uplink maximum transmission power regarding the MS;
configuring an uplink grant for the MS based on the information regarding PC;
transmitting, to the MS, the configured uplink grant; and
receiving, from the MS, uplink data generated based on the configured uplink grant and the information regarding PC.

8. The method of claim 7, further comprising:
transmitting, to the MS, an RRC connection reconfiguration message including configuration information of a CC to be configured in the MS.

9. The method of claim 8, wherein the information regarding PC is received from the MS through an RRC connection reconfiguration complete message as a response to the RRC connection reconfiguration message.

10. A mobile station (MS) for transmitting information regarding power coordination (PC) in a multi-component carrier system, the MS comprising:
a PC table storage unit storing a PC table which maps a sequence of predefined communication environment to an amount or range of PC, the communication environment being specified by the number of component carriers, and the number of supportable radio frequencies (RFs);
a PC information generation unit generating information regarding PC indicating the amount or range of PC with reference to the PC table; and
an RRC message transceiver unit transmitting an RRC message including the information regarding PC,
wherein when the number of component carriers and the number of supportable RFs are changed, the PC information generation unit changes the information regarding PC.

11. The MS of claim 10, wherein the information regarding PC is an index indicating one of the plurality of sequences.

12. The MS of claim 10, wherein a plurality of PC tables are provided based on the combination of the number of CCs and the number of sup-portable RFs, and the information regarding PC is an index indicating one of the plurality of PC tables.

13. An apparatus for receiving information regarding power coordination (PC) in a multi-component carrier system, the apparatus comprising:
an RRC message transceiver unit receiving an RRC message including information regarding PC indicating an amount or a range of power which is used to adjust maximum transmission power of uplink transmission;
a scheduling unit configuring a scheduling parameter;
a scheduling validity determination unit determining whether or not uplink transmission based on the configured scheduling parameter is made within the range of maximum transmission power; and
an uplink grant transmission unit transmitting an uplink grant comprising the configured scheduling parameter.

14. The apparatus of claim 13, wherein the information regarding PC is determined specifically by at least one of the scheduling parameter, the number of CCs, and the number of supported RFs.

15. The apparatus of claim 13, wherein the scheduling validity determination unit determines whether or not the uplink transmission based on the configured scheduling parameter is made within the range of the maximum transmission power, based on the information regarding PC and the configured scheduling parameter.
